(19) United States
(12) Patent Application Publication
(10) Pub. No.: US 2005/0149310 A1
(43) Pub. Date: Jul. 7, 2005

(54) Method for integrating ethernet switch system and RTL design environment

(75) Inventors: Jeen-Dar Huang, Hsinchu (TW); Ming-Chang Su, Hsinchu (TW)

Correspondence Address: BRUCE H. TROXELL, SUITE 1404, 5205 LEESBURG PIKE, FALLS CHURCH, VA, 22041, US

(73) Assignee: ADMtek Incorporated

(21) Appl. No.: 10/793,780

(22) Filed: Mar. 8, 2004

(30) Foreign Application Priority Data
Dec. 5, 2003 (TW) 92134272

(51) Int. Cl. G06F 9/45

(52) U.S. Cl. 703/14; 703/22

(57) ABSTRACT

The present invention relates to a method for integrating an Ethernet switch system and a RTL design environment. The primary object of the present invention is to create a common communication channel between a system designer and an IC designer, more particularly to provide a converter program capable of converting a system verification means into a source of RTL verification, and the converter further having a function of self comparison, such that a fast and universal verification flow and database can be attained, and therefore a common consensus can be acquired between the system designer and the IC designer so as to reduce the product defects caused by designing. Moreover, an originally graphic user interface (GUI) is transformed into an ASCII character table to make the system designer and the IC designer have a good communication interface.

### 1. FIELD OF THE INVENTION

The present invention relates to a method for integrating an Ethernet switch system and a RTL design environment, and more particularly, to a converter program capable of converting a system verification means into a source of RTL verification, and further having a function of self comparison, such that a fast and universal verification flow and database can be attained.

### 2. BACKGROUND OF THE INVENTION

In the process of single chip design, system verification is a very important task. Although the traditional verification method is simple to implement, it requires an engineering work of high quality and takes an overly long time for verification. Functional verification becomes as a greater resource consumer than the actual design. To reduce design engineering design pressure and increase company competition ability to meet time to market, reusable design methodology is now a popular way to reduce the design time of a new product. There are a lot of inherited system verification know-how sources becoming a successful key to integrate design flow.

Please refer to FIG. 1, which is a schematic block diagram depicting a communication method between system designers and IC designers according to prior art. Operationally, there's no preferred communication method between the system designer 11 in system verification and the IC designer 16 in RTL design environment. As seen in FIG. 1, a test is being performed using a test case 12 designed by the system designer 11 for testing a field programmable gate array(FPGA)/simulator with system board 13. At the same time, another test is also being performed independently using a test case 17 designed by the IC designer 16 for enabling a test to a RTL design environment 18. The lack of inter-verifying operation between the FPGA/simulator with system board 13 and the RTL design environment 18 results in that there's no way the know whether the two testing result are consistent with the originally speculation of the system designer 11 or not. Especially, specification miss of device is not easily transparent to discover in system boards. It always takes a lot of time to argue what root cause is from, or to difficultly verify design mismatch.

### SUMMARY OF THE INVENTION

To resolve the above drawbacks of the prior art, the present invention discloses a method for integrating an Ethernet switch system and a RTL design environment. The primary object of the present invention is to create a common communication channel between a system designer and an IC designer, more particularly to provide a converter program capable of converting a system verification means into a source of RTL verification, and the converter further having a function of self comparison, such that a fast and universal verification flow and database can be attained.

Another object of the present invention is to provide a interface with good communication for the system designer and the IC designer such that an originally graphic user interface (GUI) is transformed into an ASCII character table. Because previous test case setup always limit on measure equipment original format, every green engineers will take a lot of training course to pick up acknowledge. It causes difficultly communicate problem. This GUI interface will translate to common communication concept, which reduces uncertain test case definition and increases next project reference.

Following drawings are cooperated to describe the detailed structure and its connective relationship according to the invention for facilitating your esteemed members of reviewing committee in understanding the characteristics and the objectives of the invention.

### BRIEF DESCRIPTION OF THE DRAWINGS

FIG. 1 is a schematic block diagram depicting a communication method between a system designer and an IC designer according to prior arts.

FIG. 2 is a schematic block diagram depicting a communication method between a system designer and an IC designer according to the present invention.

FIG. 3 is a schematic flow chart between a system designer and an IC designer in accordance with the present invention.

FIG. 4 is a detailed flow chart between a system designer and an IC designer in accordance with the present invention.

### DESCRIPTION OF THE PREFERRED EMBODIMENT

For your esteemed members of reviewing committee to further understand and recognize the objectives, the characteristics, and the functions of the invention, a detailed description in matching with corresponding drawings are presented as the following.

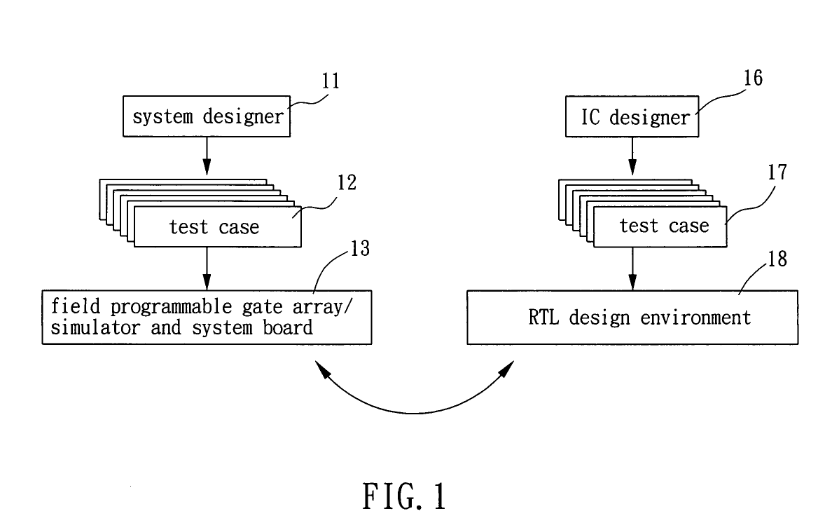

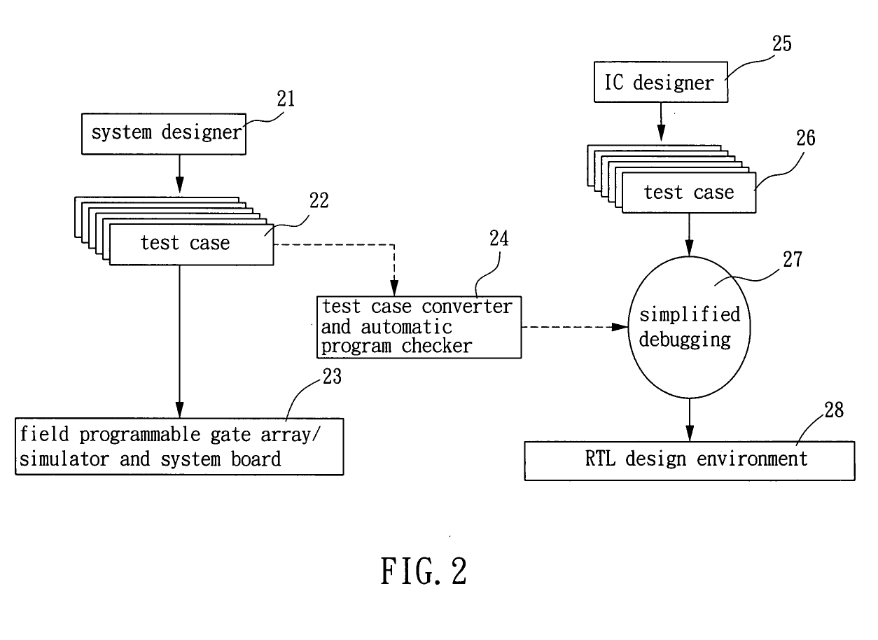

Referring to FIG. 2, is a schematic block diagram depicting a communication method between a system designer and an IC designer according to the present invention. Similar to FIG. 1 that a test is being performed using a test case 22 designed by the system designer 21 for testing a FPGA/simulator with system board 23, and at the same time, another test is also being performed using a test case 26 designed by the IC designer 25 for enabling a test to a RTL design environment 28. The differences between the FIG. 1 and FIG. 2A are that a test case converter with auto-function checker is arranged right after the test case 22 for performing an operation of easy debug 27 in-between the test case 26 and the RTL design environment 28. By the linkage of the test case converter with auto-function checker 24 and the easy debug 27, the system designer 21 can successfully verify that whether the product designed by the IC designer 25 is conformed to the original specification.

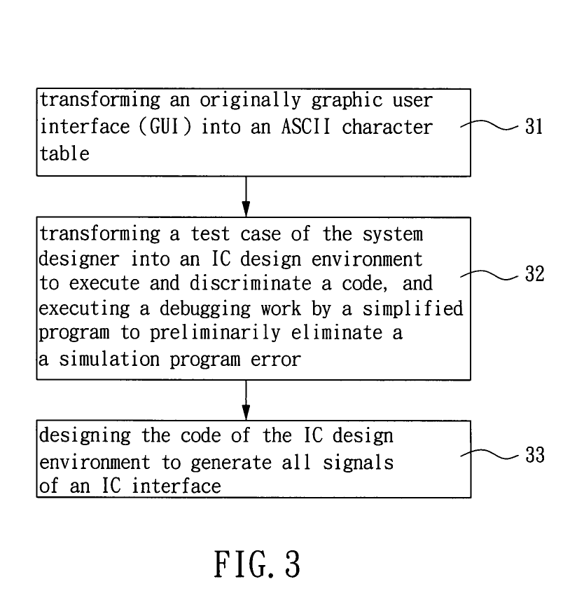

Referring to FIG. 3, which is a schematic flow chart between a system designer and an IC designer in accordance with the present invention. The method for integrating an Ethernet switch system and a RTL design environment is capable of achieving a communication channel between a system designer and an IC designer using a converter program for converting a system verification means into a source of RTL verification, and further having a function of self comparison, such that a fast and universal verification flow and database can be attained, comprising:
(a1) transforming an originally graphic user interface (GUI) into an ASCII character table 31;
(b1) converting a test case of the system designer into that of an IC design environment for executing and verifying a code, and further executing an operation of debug using a simplified program for preliminarily eliminating errors in a simulation program 32; and
(c1) designing the code of the IC design environment for generating every signal of an IC interface 33.

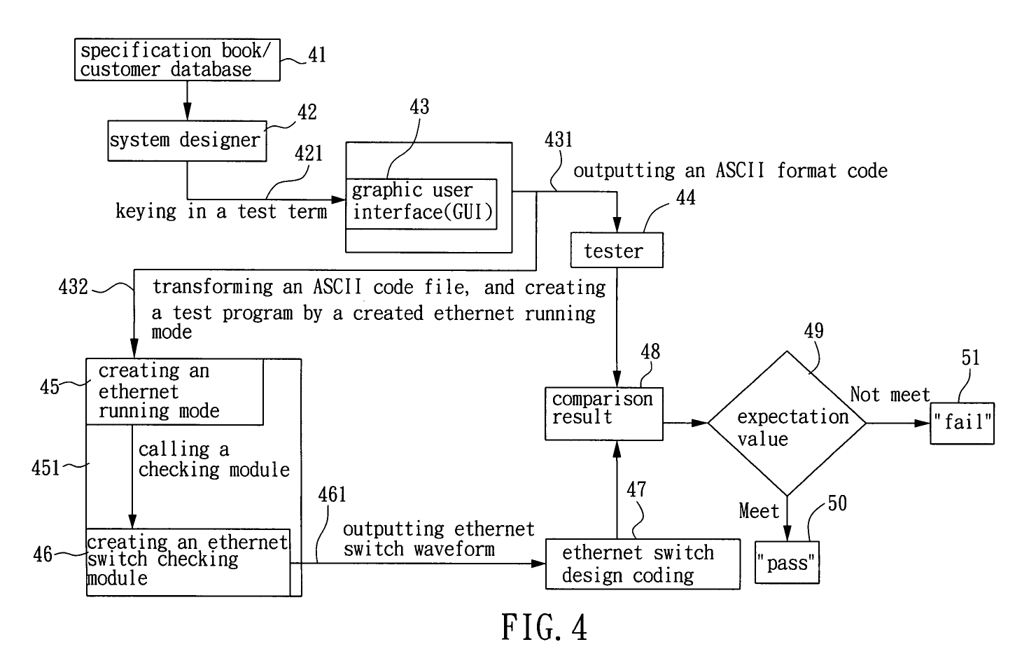

Referring to FIG. 4, which is a detailed flow chart between a system designer and an IC designer in accordance with the present invention. The flow chart comprises the following steps: First, a test items 421 is being keyed in after a specification and a customer database 41 is obtained by a system designer 42 so as to form a graphic user interface (GUI) 43; and then, following a first processing path that the graphic user interface (GUI) 43 is transformed into an ASCII code 431, and the ASCII code is fed into a tester 44 so as to generate a first result.

On the other hand, a second processing path will convert the ASCII code file, and build test programs 432 referring to a built Ethernet behavior task. The test program comprises:
(1) building an Ethernet behavior task 45;
(2) calling a verification model 451; and
(3) creating an Ethernet switch verification model 46.

An Ethernet switch waveform 461 is outputted after the ASCII code file passes the foregoing three test program, and the Ethernet switch waveform 461 is then coded by an Ethernet switch design code 47 so as to generate a second result.

Following. An evaluation is being made to compare the first result and the second result with an expectation value 49 such that a comparison result 48 is obtained. If the result of the comparison matches a prescribed specification, then the verification is regarded as “pass” 50; otherwise, the verification is regarded as “fail” 51.

As seen from FIG. 2 to FIG. 4, it is clearly understood that the present invention is to create a common communication channel between a system designer and an IC designer, more particularly to provide a converter program capable of converting a system verification means into a source of RTL verification, and the converter further having a function of self comparison, such that a fast and universal verification flow and database can be attained, and therefore a common consensus can be acquired between the system designer and the IC designer so as to reduce the product defects caused by designing.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. A method for integrating an Ethernet switch system and a RTL design environment for creating a common communication channel between a system designer and an IC designer, comprising:
transforming an graphic user interface into an ASCII character table;
converting a test case of said system designer into that of said IC design environment for executing and verifying a code; and further executing an operation of debug using a simplified program for preliminarily eliminating errors in a simulation program 32
designing said code of said IC design environment to generate signals of an IC interface.

2. The method of claim 1, further comprising:
Operating a debug using a simplified program on said converted test case to preliminarily eliminate errors of a simulation program.

3. A method for integrating an Ethernet switch system and a RTL design environment for creating a common communication channel between a system designer and an IC designer, comprising:
keying in a test item after a specification and a customer database is obtained by a system designer so as to form a graphic user interface;
following a first processing path that said graphic user interface is transformed into an ASCII code, and then said ASCII code is fed into a tester so as to generate a first result;
converting said ASCII code file following a second processing path, and building test programs 432 with reference to a built Ethernet behavior task;
outputting an Ethernet switch waveform after said files being verified by said test programs, and generating a second result by using a Ethernet switch design code to code said Ethernet switch waveform; and
comparing said first result, said second result with an expectation value, and, if a result of said comparison matches a prescribe standard, said verification is regarded as “pass”; otherwise, said verification is regarded as “fail”.

4. The method of claim 1, wherein said test program further comprising:
(1) building an Ethernet behavior task;
(2) calling a verification model; and
(3) creating an Ethernet switch verification model.
